(19) United States
(12) Patent Application Publication
(10) Pub. No.: US 2026/0203800 A1
(43) Pub. Date: Jul. 16, 2026

(54) SYSTEM AND METHOD FOR CONSENT-BASED VISUAL LIKENESS IDENTIFICATION, VERIFIED CONTENT GENERATION, AND MULTI-INPUT SEARCH WITH PRIVACY COMPLIANCE

(71) Applicant: Regina DeBellis, Staten Island, NY (US)

(72) Inventor: Regina DeBellis, Staten Island, NY (US)

(21) Appl. No.: 19/387,297

(22) Filed: Nov. 12, 2025

Related U.S. Application Data
(63) Continuation-in-part of application No. 19/017,132, filed on Jan. 10, 2025.

(51) Int. Cl. G06Q 30/0601

(52) U.S. Cl. CPC G06Q 30/0607; G06Q 30/06211

(57) ABSTRACT

A system and method are provided for consent-driven visual likeness identification and verified content generation within a closed, privacy-compliant platform. The system includes a multi-step user consent interface requiring affirmative authorization prior to any likeness scan, an internal opt-in visual likeness recognition engine for identifying verified users, a real-time alert subsystem for notifying matched users of scan activity, and a conditional public likeness lookup engine performing one-time, non-persistent searches limited to publicly visible images and URLs. The system further includes an image and Smartbook module enabling verified users to upload, organize, and generate keepsake products from approved media, with optional AI layout assistance and blockchain archival of ownership data. A verified multi-input feed search engine allows keyword, date, location, or likeness-based queries restricted to consent-authorized content within the closed network.

### CROSS-REFERENCE TO RELATED APPLICATIONS

The present application claims priority to and is a continuation-in-part of U.S. Non-Provisional application Ser. No. 19/017,132 filed Jan. 10, 2025, titled “SYSTEM AND METHOD FOR REAL-TIME IDENTIFICATION, BEHAVIORAL ANALYSIS, AND LOCATION-BASED SERVICES USING MULTI-LAYERED ANALYTICS” which is hereby incorporated by reference in its entirety.

### TECHNICAL FIELD

The embodiments disclosed herein generally relate to systems and methods for identifying and verifying individuals, and more specifically relates to systems and methods for real-time identification, verification, and behavioral monitoring using facial recognition, internet data scrubbing, geolocation, and device-to-device communication technologies.

### BACKGROUND

Over the past two decades, identity verification technologies have evolved from password-based authentication to complex biometric recognition systems capable of analyzing facial, voice, and behavioral data in real time. These systems have been integrated into social media platforms, mobile applications, and enterprise-level security frameworks to streamline user access, automate verification, and enhance safety. While these technologies have achieved remarkable progress in accuracy and scalability, they often operate in opaque environments where users have limited control over how their biometric information is collected, stored, or utilized. As a result, there has been an increasing need for systems that balance the benefits of real-time verification with strong ethical and legal safeguards protecting user privacy and consent.

At the same time, the proliferation of digital media and user-generated content has created vast ecosystems of personal photos, videos, and data spread across various online platforms. Many content aggregation and sharing systems rely on passive data collection, automated curation, or algorithmic inference to generate digital products and recommendations. Although these approaches improve convenience, they frequently remove users from the creative and decision-making process, undermining notions of authorship, ownership, and informed participation. Users often lack a verifiable chain of custody for their content, resulting in ambiguity surrounding who controls, modifies, or benefits from the data they create.

The emergence of artificial intelligence and automated content generation has further complicated these issues. Machine learning systems are now capable of producing lifelike imagery, performing facial matching, and suggesting social connections without explicit consent or contextual awareness. This has heightened public concern regarding unauthorized likeness use, deepfake creation, and the blending of synthetic and authentic media. The absence of transparency in such processes not only erodes user trust but also introduces significant legal exposure for platforms that fail to comply with privacy and data protection regulations. A new technical approach is needed, one that embeds user consent, transparency, and auditability into the foundational layers of facial recognition and media management workflows.

In addition, traditional search and discovery mechanisms within social and media networks often rely on behavioral analytics, social graph inference, and predictive ranking algorithms that operate beyond user control. These models emphasize engagement metrics over ethical data handling, leading to inadvertent exposure of personal information and associative profiling. Users require more granular, user-defined control over how searches are conducted, what data can be surfaced, and under what circumstances likeness-based matching is permissible. A secure, consent-based alternative would allow users to navigate shared digital environments with confidence that all content and identities surfaced have been voluntarily authorized.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein disclose a system, method, and computer-readable medium for consent-driven visual likeness identification and verified content generation within a closed, privacy-compliant digital platform. The system introduces a user-centered consent architecture that governs each stage of visual likeness scanning, verified content creation, and structured media search. By requiring multi-step consent and restricting all data interactions to verified participants, the invention ensures transparency, security, and ethical compliance. Each component operates under a unified privacy policy, allowing voluntary participation and verifiable consent at every stage. Through this integration, the invention establishes a new model of digital ecosystems where identity verification and media generation occur safely and lawfully.

In one embodiment, the system includes a multi-step user consent interface configured to obtain explicit authorization from a user before initiating any likeness scan. The interface presents sequential confirmations requiring the user to affirm age eligibility, declare non-malicious intent, and provide optional approval for a public likeness lookup if no internal match is found. This design prevents unintentional or unauthorized scanning while ensuring that each scan occurs only under informed user participation. The consent process functions as the entry point for all subsequent modules within the system. All consent inputs are digitally time-stamped and recorded for session verification. This architecture provides a transparent foundation for lawful biometric interactions.

The multi-step user consent interface prevents the execution of any likeness scan until the user provides full authorization. Each confirmation is stored in a temporary audit layer that ensures accountability while maintaining minimal data retention. Once consent is complete, the interface transmits a secure signal to the internal recognition engine, which unlocks scanning privileges for that specific session. This separation between the interface and the recognition module preserves the boundary between user control and automated processing. The consent interface therefore functions as a safeguard that ensures all biometric activities remain voluntary, traceable, and compliant.

The invention further comprises an internal opt-in visual likeness recognition engine configured to identify verified users within a closed platform network. The engine performs image comparisons only on data voluntarily submitted by users who have opted into verification. All biometric operations are confined to the platform's internal storage environment and cannot access or retrieve data from third-party databases. This ensures that the recognition process remains isolated, secure, and compliant with privacy regulations. The engine provides the foundation for verified identity confirmation within a contained and lawful ecosystem.

The internal opt-in visual likeness recognition engine uses proprietary facial feature mapping to perform identity verification in real time without storing persistent biometric vectors. When a match is found, the engine reveals only public information that the matched user has pre-approved for disclosure. Sensitive personal data, identifiers, and behavioral attributes remain hidden or inaccessible. The system then deletes any temporary scan data once the operation concludes. This method provides verification accuracy without compromising personal privacy or generating reusable biometric records.

The system also includes a real-time alert subsystem configured to notify a matched user immediately when another verified user scans their likeness. The alert subsystem maintains visibility over all likeness interactions and includes both in-app and external notification options. Each alert specifies the scanning user's identity and the time of the event, allowing the matched user to acknowledge or contest the interaction. All alerts are stored in encrypted logs for verification or dispute resolution. The subsystem provides both transparency and deterrence against unauthorized use, thereby reinforcing trust within the network.

The real-time alert subsystem further includes an auditable event record that links every likeness scan to its corresponding consent record. These encrypted logs are retained for compliance verification but are not shared outside the affected user accounts. The matched user can review historical notifications and verify when and by whom their likeness was accessed. This dual notification and logging process enables a complete trace of all facial identification activity within the system. The transparency of the alert subsystem forms a key distinction between this invention and conventional recognition technologies that lack user feedback mechanisms.

In another embodiment, the system includes a conditional public likeness lookup engine configured to perform one-time searches for publicly available likeness images. The engine activates only after explicit user authorization is obtained through the consent interface. It searches existing web indexes for visual matches and retrieves corresponding image thumbnails and URLs. The lookup excludes names, metadata, or biometric confidence scores and performs no persistent storage of results. The operation ends automatically upon completion, leaving no residual data or identifiable user trail. This configuration ensures compliance with data minimization and right-to-erasure principles.

The conditional public likeness lookup engine operates in a constrained environment where search results are limited to already published public content. It does not reindex, harvest, or copy third-party data. Each session is isolated, ensuring that the output exists only for the duration of that lookup. The user has full discretion to terminate or disable the public lookup option at any time. This functionality allows legitimate use cases, such as verifying media authenticity, while maintaining privacy compliance. The architecture therefore enables responsible visual search within lawful limits.

Collectively, the multi-step user consent interface, internal opt-in visual likeness recognition engine, real-time alert subsystem, and conditional public likeness lookup engine form a cohesive consent-driven identity framework. These modules work together to guarantee that every likeness interaction occurs with user awareness, consent, and limited scope. The framework eliminates silent data collection, bulk scraping, and involuntary biometric processing. Each module independently enforces its privacy boundaries yet contributes to the overall functionality of the system. This integration delivers a technically advanced yet ethically aligned solution for digital identity management.

The invention also includes a Picture Pool and Smartbook module that enables verified users to generate digital or physical keepsake products from their uploaded content. The Picture Pool serves as a secure, opt-in environment where users can collaborate on event-based collections. All content must originate from user uploads and cannot be imported from third-party platforms. The Picture Pool ensures content integrity, consent compliance, and clear ownership attribution. By combining creative functionality with verification logic, the invention extends user trust into the content generation domain.

The Picture Pool and Smartbook module includes a tag-activated contribution system where users can add others by tagging or invitation. Only verified users within the platform may participate, ensuring that every contributor maintains a valid consent relationship. Each participant can upload, vote, and organize photos or videos within the shared space. Voting features allow collaborative input on preferred images while preserving the creator's control over final selections. This structure encourages social engagement without compromising privacy or authorship rights.

The Picture Pool and Smartbook module includes an AI layout assistant that supports the user during Smartbook creation. The assistant provides design suggestions, caption templates, and layout enhancements only after the user initiates the Smartbook process. It does not auto-curate or auto-generate products independently. The user remains the exclusive decision-maker throughout the design process. This AI augmentation approach maintains creative control while streamlining production efficiency and consistency.

The invention also includes a Remove-Me control mechanism integrated into the Picture Pool and Smartbook module. This control allows any tagged user to withdraw consent for their likeness to appear in shared media or generated products. Upon withdrawal, the system automatically removes the image, updates associated metadata, and regenerates layouts to preserve design continuity. This feature provides dynamic control over likeness usage and long-term consent management. It ensures that privacy rights remain enforceable after publication or sharing.

The system optionally includes a blockchain archival subsystem configured to record immutable ownership and authorship metadata for finalized keepsakes or Smartbooks. Once activated, the subsystem generates a secure ledger entry containing timestamp data, ownership verification, and authorship identifiers. These entries provide proof of authenticity and chain of custody for digital and physical products. The blockchain record never includes personal biometric data or unencrypted user information. This mechanism guarantees verifiable integrity of user-generated works across distributed environments.

The blockchain archival subsystem integrates with the Picture Pool and Smartbook module to preserve content authenticity over time. Users may enable blockchain archival when publishing a Smartbook or exporting a digital product. The blockchain ledger functions as a public record confirming authorship and ownership. The subsystem supports optional license verification for commercial use while maintaining user discretion. This feature provides users with verifiable intellectual property protection for their media creations.

The invention also provides a verified multi-input feed search engine configured to locate media within the closed platform using multiple input criteria. Users may filter results by keyword, date, location, identity tag, or uploaded likeness image. The engine processes inputs through a structured sequence that prioritizes user-owned content, shared media, and finally likeness-based searches. Each layer is constrained to verified, consent-based sources. The hierarchical search design guarantees that users only access data within their authorized network.

The verified multi-input feed search engine employs modular dropdown selectors and upload tools to simplify query construction. Search results appear in a chronological, filterable feed displaying thumbnails, captions, and event metadata. The engine excludes any data not explicitly shared with or accessible by the querying user. This configuration provides transparency and prevents exposure of unauthorized content. It replaces social-graph inference with structured, rule-based filtering to reinforce ethical data handling practices.

In some embodiments, the system includes a compliance monitoring subsystem that audits consent logs and likeness interactions for regulatory adherence. This subsystem periodically reviews consent confirmations and verifies that each biometric event corresponds to a valid authorization record. It can generate automated reports suitable for legal or organizational compliance reviews. These reports provide verifiable evidence of data protection measures in place. The subsystem ensures continuous conformity with evolving data governance standards.

The invention may further include an automated audit logging server that consolidates event histories from all modules into a secure repository. This server maintains cryptographically signed logs of consent events, likeness scans, Smartbook creations, and blockchain entries. Authorized administrators can access summarized audit data for policy enforcement or dispute resolution. The server uses encryption and access control to protect audit integrity. This centralized logging process reinforces accountability throughout the system.

The system may also integrate a content moderation workflow to review user-submitted media before publication or archival. Moderators may verify that uploaded images comply with platform guidelines and do not violate external intellectual property rights. The workflow operates asynchronously, allowing moderation without disrupting real-time user interactions. Approved content proceeds to the Picture Pool or Smartbook stage automatically. This moderation step enhances the reliability and reputation of the closed network.

Another embodiment includes a consent verification API that allows external services to confirm whether a likeness scan or media use is authorized under the platform's consent policies. The API transmits anonymized confirmation tokens without revealing user identities. This enables interoperability with compliant third-party services such as photo printers or digital rights verifiers. The API ensures that downstream services respect the original user consent framework. By doing so, it extends the invention's privacy-centric principles beyond the core platform.

The invention can also support distributed deployment architectures that replicate system modules across multiple servers or data centers. This configuration improves redundancy, latency, and compliance with regional data storage regulations. Each node within the network enforces identical consent and privacy rules. Synchronization protocols ensure that user permissions remain consistent across deployments. This distributed design allows global scalability without compromising security or user control.

The integration of these components provides both technical and legal advantages. The system ensures that all biometric operations, media generations, and searches are governed by explicit user consent. Each transaction is traceable, auditable, and compliant with applicable privacy laws. The architecture combines identity verification, creative collaboration, and secure recordkeeping into one unified process. This creates a self-contained platform for ethical digital interaction and verified content generation.

Accordingly, the invention provides a comprehensive technical solution for consent-driven likeness identification, verified content creation, and privacy-preserving search within a closed digital network. Through the integration of the multi-step user consent interface, internal opt-in visual likeness recognition engine, real-time alert subsystem, conditional public likeness lookup engine, Picture Pool and Smartbook module, blockchain archival subsystem, and verified multi-input feed search engine, the system establishes a user-controlled, transparent, and compliant framework for digital identity management. Each inventive component operates under explicit consent, ensuring accountability and respect for user rights. The system defines a next-generation architecture for ethical technology deployment across social, commercial, and creative domains. It therefore represents a transformative advancement in privacy-centric computing and user-verified digital ecosystems.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 is a block diagram illustrating an exemplary computing system comprising modules and engines configured to perform consent-driven visual likeness identification, verified content generation, and related data management operations, according to some embodiments; and

FIG. 3 is a flowchart illustrating an exemplary method for performing consent-driven visual likeness identification and verified content generation using the multi-step user consent interface, visual likeness recognition engine, real-time alert subsystem, conditional public likeness lookup engine, and Picture Pool and Smartbook module, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a system, method, and computer-readable medium configured for consent-driven visual likeness identification and verified content generation within a closed and privacy-compliant digital platform. The system may provide a structured, consent-based workflow that governs the capture, comparison, and use of visual likeness data while ensuring that each user maintains control over their biometric information. Each functional module may interact through secured communication channels and encrypted data structures to ensure transparency and compliance. The described components may operate together to enable verified user interactions, secure media creation, and structured search capabilities across a closed network.

The Picture Pool and Smartbook module may function as an image module within the computing system and may be responsible for receiving, processing, organizing, and generating verified visual media. As an image module, it may manage both static and dynamic image data uploaded by verified users and may include routines for tagging, metadata association, and image normalization consistent with platform standards. The module may further enable users to create composite visual products, such as digital albums or Smartbooks, by selecting and arranging verified images within a consent-controlled environment. The image module may interface with the database engine to store and retrieve media assets and may communicate with the blockchain archival subsystem to register ownership and authorship metadata. In some embodiments, the Picture Pool and Smartbook module may also include the AI layout assistant and Remove-Me control mechanism as subcomponents of the image processing framework, ensuring that all visual content generation occurs within a verifiable and privacy-compliant workflow.

The system may include a multi-step user consent interface that operates as the entry point for all visual likeness scans and identity verification processes. The interface may sequentially present consent statements requiring the user to confirm eligibility, intent, and authorization for scanning activities. Each confirmation may be digitally recorded, time-stamped, and linked to a corresponding user identifier. The system may prevent any likeness recognition or data processing from proceeding until the required consents are affirmatively completed. By structuring the consent process as a prerequisite to further operation, the interface may ensure that all data interactions remain voluntary and traceable.

The multi-step user consent interface may be implemented as a software module integrated into a web application, mobile application, or embedded platform interface. Each consent prompt may include dynamic user interface elements such as toggle confirmations or biometric signature acknowledgments. The interface may include conditional logic allowing different levels of access based on user selections, such as whether a public likeness lookup is permitted. In one configuration, the consent interface may transmit encrypted tokens to the internal recognition engine authorizing session-specific operations. Once the session concludes, the consent authorization may expire to prevent reuse or misapplication.

The system may further include an internal opt-in visual likeness recognition engine that processes user-submitted likeness data to identify verified members within the closed platform. The recognition engine may perform image analysis by generating temporary feature maps that are compared to enrolled user profiles stored within an internal database. The database may contain only images voluntarily submitted by verified users, and all image processing may occur within an isolated computational environment. The recognition engine may discard feature vectors and temporary data upon completion of each operation, maintaining a non-persistent approach to biometric comparison. The architecture may thereby support secure and compliant identification without permanent storage of biometric metadata.

The internal opt-in visual likeness recognition engine may utilize standard computer vision algorithms such as convolutional neural networks or statistical facial embedding systems to achieve reliable image matching. Feature extraction may occur on-device or within a server-controlled virtual machine, depending on deployment configuration. The matching process may yield a verified match confidence value, which may then be transmitted to the application interface for user review. In certain embodiments, the engine may allow adjustable thresholds for match confidence to balance precision and recall according to operational requirements. This flexible architecture may accommodate both consumer and enterprise deployments with minimal modification.

A real-time alert subsystem may operate in conjunction with the recognition engine to notify a matched user when their likeness is scanned by another verified user. This subsystem may generate an alert message containing contextual data such as the scanning user's identity, timestamp, and geographic location (if enabled). The matched user may receive this alert through in-app notifications, SMS, or email delivery, depending on configured preferences. The alert subsystem may also record the event in an auditable log for future verification. Each log entry may include the consent record, recognition session ID, and delivery confirmation status, allowing for complete traceability of every likeness interaction.

The real-time alert subsystem may include a communication layer that utilizes message queuing and encryption to ensure reliable and secure notification delivery. The subsystem may be implemented using asynchronous messaging protocols to prevent performance degradation during high-volume operations. Users may have the option to acknowledge or dispute a scan directly from the alert interface, triggering follow-up verification or administrative review. This dynamic response capability may serve as both a transparency feature and a safeguard against unauthorized likeness activity. The subsystem may also support automated escalation workflows that notify compliance administrators in response to disputed scans.

The system may optionally include a conditional public likeness lookup engine configured to perform one-time likeness searches across publicly visible image data sources. This module may activate only after explicit user authorization and may operate under session-based execution conditions. During operation, the lookup engine may query existing web indexes or open databases using image similarity algorithms. Results may include image thumbnails and associated URLs but exclude any biometric or personal identifiers. Once the session completes, the lookup engine may automatically clear all temporary data and revoke access tokens, ensuring that no residual data is retained.

The conditional public likeness lookup engine may be built upon a modular API layer that connects to licensed public indexing services or localized mirrors of open datasets. Query results may be filtered by relevance, time, or location parameters, depending on user preferences and consent scope. The engine may incorporate hash-based de-duplication to eliminate redundant search results. Results may be displayed in a visual grid format for user review and may allow the user to select images for further verification. The ephemeral operation of this engine may ensure that public likeness searches remain compliant with data protection and right-to-be-forgotten regulations.

The system may further include a Picture Pool and Smartbook module that enables verified users to upload, organize, and generate creative content within the platform. The Picture Pool may function as a collaborative media repository where users can contribute photographs, videos, or graphics to shared collections. Each contribution may include metadata such as contributor ID, timestamp, and event tags. Once collected, media assets may be automatically synchronized for use in Smartbook generation workflows. The Smartbook process may allow users to design digital or physical keepsake products based on approved media selections.

The Picture Pool and Smartbook module may include an AI layout assistant that automatically arranges media elements according to user preferences and theme templates. The assistant may analyze image composition and metadata to recommend page layouts, caption placements, or visual ordering. Users may adjust or override all automatically generated layouts through drag-and-drop controls. The AI layout assistant may utilize adaptive algorithms that learn from user behavior over time to improve future layout suggestions. The combination of manual and automated design capabilities may streamline content production while preserving creative flexibility.

The system may include a Remove-Me control mechanism within the Picture Pool and Smartbook module. This mechanism may allow a user to remove their likeness from any shared or generated content. When activated, the system may locate instances of the user's likeness using stored tagging or facial vector references and automatically mask or remove those portions from the media. Updated content may then be regenerated without altering the remaining design elements. This feature may maintain continuous user control over likeness representation across shared collections and published products.

A blockchain archival subsystem may be included to store immutable records of ownership, authorship, and content creation events related to Smartbook products or verified interactions. The subsystem may generate a transaction record that includes hashed identifiers, timestamps, and user consent references. The blockchain ledger may be implemented using a public or private distributed ledger technology. Entries may be verified through consensus mechanisms that prevent modification or deletion of recorded data. This subsystem may ensure long-term traceability and authenticity of user-generated content.

The blockchain archival subsystem may interact with the Picture Pool and Smartbook module through a digital signing process that associates verified ownership metadata with final products. When a Smartbook or media collection is finalized, the subsystem may generate a blockchain transaction that cryptographically links the content to its verified creator or contributors. This process may produce a digital certificate of authenticity accessible through the platform. The same process may be used to verify future reproductions or licensing requests. All blockchain operations may occur asynchronously to minimize latency during user interactions.

The system may further include a verified multi-input feed search engine that enables users to locate and retrieve consent-authorized content. The search engine may accept multiple query types, including text, tags, timestamps, and likeness images. Each search layer may be executed in order of scope, beginning with user-owned content and extending to shared or publicly approved data. The search engine may index internal data structures using relational or graph-based models to optimize response times. All retrieved data may be filtered through access-control rules that ensure compliance with each user's consent preferences.

The verified multi-input feed search engine may incorporate natural language processing to interpret user queries and match them to available metadata fields. For likeness-based searches, the engine may temporarily engage the internal recognition module for visual matching. Results may be displayed in a structured feed format that includes source identifiers, timestamps, and visibility permissions. Each result may include actionable elements allowing users to view, export, or request removal of specific content. This flexible search architecture may provide precise retrieval while maintaining strict privacy enforcement.

In some embodiments, the system may include a compliance management component configured to verify that each operational event aligns with stored user consent records. The component may periodically audit interactions and generate reports indicating consent validity, processing logs, and notification history. These reports may be used internally or exported to administrative tools for regulatory compliance. Each audit event may include the cryptographic identifiers associated with the user's authorization, ensuring authenticity and traceability. This structure may support both automated and manual verification of lawful data use.

In implementation, all modules may operate within a distributed computing environment using secure APIs, authentication tokens, and encrypted communications. The platform may be deployed on centralized servers, decentralized peer nodes, or hybrid architectures. Each functional element, including the multi-step user consent interface, internal opt-in visual likeness recognition engine, real-time alert subsystem, conditional public likeness lookup engine, Picture Pool and Smartbook module, blockchain archival subsystem, and verified multi-input feed search engine, may interact through defined protocols and structured data exchange. These configurations may enable consistent enforcement of consent and authorization across the platform's components. By combining privacy-first design principles with modular extensibility, the system may provide a secure, scalable, and fully auditable digital framework.

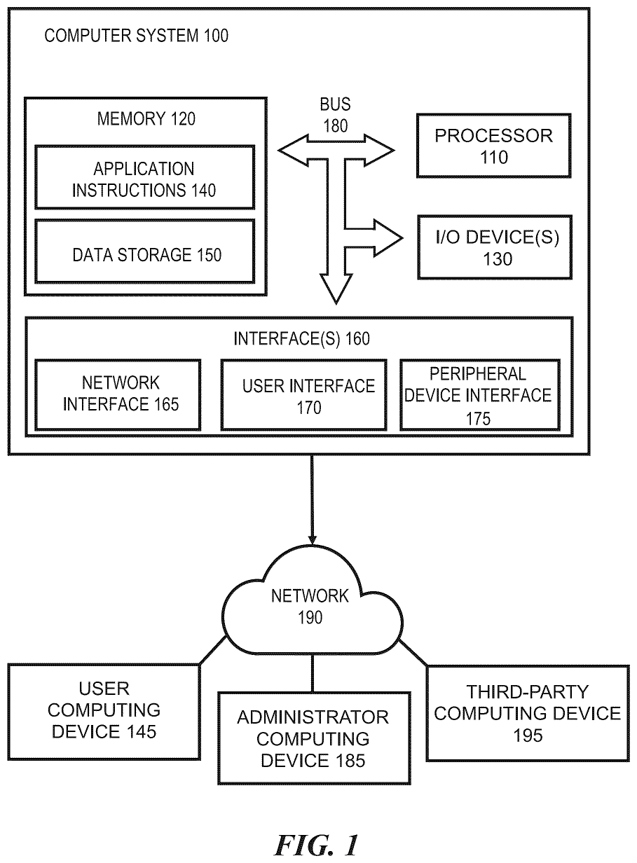

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145 an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

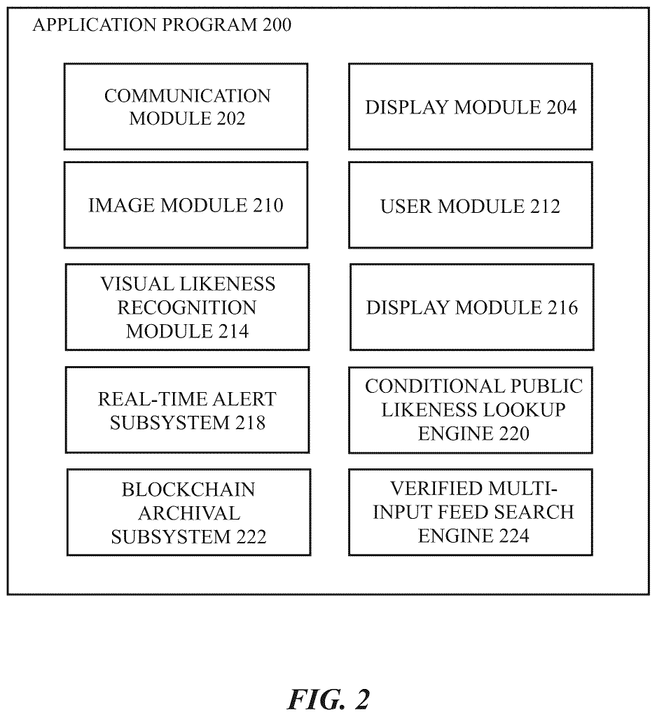

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, an image module 210, a user module 212, a visual likeness recognition module 214, a display module 216, a real-time alert subsystem 218, a conditional public likeness lookup engine 220, a blockchain archival subsystem 222, and a verified multi-input feed search engine 224.

Referring again to FIG. 2, the computing system 100 may include an application program 200 that coordinates data exchange among multiple software modules and engines. The system may operate on a distributed network environment having one or more servers, databases, and client computing devices. The application program 200 may use a modular framework in which each module executes defined instructions and shares data through an internal messaging bus. Each engine may perform data interpretation, processing, or analysis to support user operations. This configuration allows system 100 to execute identity verification, consent management, and media generation workflows concurrently across secure network channels.

The communication module 202 may manage all inbound and outbound data transmissions between the user computing device and the application server. This module may employ standard protocols such as HTTPS, WebSocket, or REST API calls to ensure encrypted communication. The communication module 202 may also perform token-based authentication using OAuth or similar frameworks to verify session validity. In operation, this module may serialize user commands, transmit consent confirmations, and relay processed recognition data from other modules. The communication module 202 may additionally control asynchronous notifications triggered by the real-time alert subsystem 218 to guarantee reliable delivery under variable network conditions.

The database engine 204 may control storage, indexing, and retrieval of structured and unstructured data used throughout the platform. It may maintain distinct repositories for user profiles, consent logs, media files, and blockchain metadata. The database engine 204 may implement relational or document-oriented schemas depending on the operational deployment. Each dataset may be encrypted at rest using symmetric or asymmetric encryption keys. The database engine 204 may further provide query optimization and transactional integrity services that allow simultaneous read and write operations without compromising data consistency.

The image module 210 may manage all image-related operations including acquisition, pre-processing, and normalization. When a user uploads an image or initiates a camera capture, the image module 210 may perform color correction, cropping, and resolution adjustment to meet predefined recognition standards. The module may convert image data into standardized pixel arrays suitable for processing by the visual likeness recognition module 214. In certain embodiments, this module may include compression routines and metadata extraction components. The image module 210 may serve as the input gateway for any process involving facial or visual analysis.

The user module 212 may handle account creation, profile management, and session tracking for verified users within the closed platform. Each profile record may include identifiers, preferences, and verification status associated with consent history. The user module 212 may manage authentication tokens, access control levels, and role assignments that define permissible system actions. During active sessions, it may continuously synchronize user settings with the communication module 202 to maintain a consistent state across devices. The user module 212 may also integrate privacy settings that govern how each user's likeness and content may be shared.

The visual likeness recognition module 214 may be responsible for identifying and verifying individuals based on opt-in image comparisons. The module may employ computer-vision techniques such as convolutional neural networks to extract feature vectors from uploaded or captured images. These vectors may be compared to encrypted templates stored in the database engine 204 to identify a potential match. The module may operate in conjunction with the multi-step user consent interface to ensure that recognition is performed only after explicit authorization. After processing, temporary vectors may be discarded to prevent long-term biometric storage.

The visual likeness recognition module 214 may further include adaptive learning capabilities that refine comparison accuracy over time using anonymized metrics. This improvement process may be restricted to aggregate performance statistics without retaining user images or identifiable data. The module may support configurable similarity thresholds that can be tuned for different applications such as access verification or social matching. It may also provide API endpoints for other modules, allowing authorized components to request verification results. Through controlled integration, the module ensures consistent use of visual likeness data across the platform.

The display module 216 may provide the graphical output layer through which users interact with the application program 200. This module may generate dynamic user interfaces for uploading images, managing consent settings, reviewing alerts, and viewing Smartbook layouts. It may employ responsive design principles to operate across desktop, mobile, and tablet environments. Data displayed by this module may originate from the database engine 204 or be streamed directly from the communication module 202. The display module 216 may also present real-time feedback from the visual likeness recognition module 214 and related components.

The real-time alert subsystem 218 may monitor and broadcast events relating to likeness scans, data access, or content usage. Upon detection of a scan that matches a verified user, this subsystem may generate a structured notification payload containing the initiator's identifier, timestamp, and relevant consent reference. The payload may be encrypted and transmitted to the matched user via the communication module 202. The real-time alert subsystem 218 may record each notification in an immutable audit table managed by the database engine 204. It may also include logic for escalation or acknowledgment workflows to ensure that each event receives a verified response.

The conditional public likeness lookup engine 220 may perform user-authorized external image searches restricted to publicly available data sources. This engine may activate only when consent tokens received from the multi-step user consent interface remain valid. It may execute one-time likeness queries using image hashing or perceptual similarity algorithms. Returned data may consist solely of thumbnail previews and source URLs, excluding any personally identifiable information. The conditional public likeness lookup engine 220 may delete all cached query data upon session termination to comply with privacy requirements.

The conditional public likeness lookup engine 220 may further include configurable parameters that define the scope and depth of each lookup. Administrators may establish limits on query frequency, search duration, and maximum returned records. The engine may maintain an internal counter to prevent repetitive searches using identical images within a specified time window. All operations may be logged and auditable to ensure compliance with consent and usage policies. The engine's modular structure may allow future integration with federated search APIs while retaining the same consent controls.

The blockchain archival subsystem 222 may manage the creation of immutable transaction records for media ownership, authorship, and verification events. It may generate cryptographic hashes of Smartbook files or consent records and store these within a distributed ledger. The subsystem may interface with public or private blockchain frameworks depending on the security requirements. Each blockchain transaction may include metadata linking a digital asset to its verified user identifiers. This process may enable permanent verification of digital products without storing personal data on the ledger itself.

The blockchain archival subsystem 222 may utilize smart-contract routines that automatically record new transactions when defined triggers occur within the platform. For example, finalizing a Smartbook layout or confirming ownership of uploaded media may prompt the subsystem to generate a blockchain entry. The system may expose verification endpoints allowing users or third parties to validate ownership using the stored hash. The blockchain archival subsystem 222 may operate asynchronously to minimize latency, queuing transactions through the communication module 202 before committing them to the ledger. This design provides a scalable method for long-term data validation.

The verified multi-input feed search engine 224 may enable users to query the system using multiple parameters simultaneously. Search inputs may include textual keywords, event tags, dates, locations, identity references, or likeness images. The search engine 224 may utilize hierarchical indexing to segment data into user-owned, shared, and public layers. Each search operation may run through a permission-filtering process that ensures only consent-authorized content is returned. The engine may further support pagination, sorting, and export functions for efficient data retrieval.

The verified multi-input feed search engine 224 may apply semantic analysis and similarity weighting to enhance search precision. When a likeness image is included in the query, the engine may temporarily invoke the visual likeness recognition module 214 to locate visually similar content among consented datasets. The results may include thumbnail previews and metadata indicating ownership, visibility, and consent level. The engine may restrict cross-user searches to verified participants only. This modular configuration may permit the integration of future search filters without altering the core consent verification architecture.

The communication module 202, database engine 204, and display module 216 may operate together as foundational infrastructure for the remaining components. These elements may provide messaging, data persistence, and user interface layers required to execute higher-level recognition, alerting, and archival functions. By separating logical concerns into distinct modules, the system may support independent development and secure scaling. This separation also facilitates real-time updates and API-based integration with third-party services. Each data transfer among modules may pass through encrypted communication channels enforced by the communication module 202.

Each engine within application program 200 may communicate through a shared application programming interface that defines standardized message formats. For instance, the visual likeness recognition module 214 may output recognition results as structured JSON objects interpreted by both the display module 216 and the real-time alert subsystem 218. The blockchain archival subsystem 222 may consume similar objects to append verified metadata to the ledger. This uniform message schema may reduce latency and simplify debugging across the distributed architecture. Standardized interaction among modules may ensure operational consistency and predictable behavior under varied workloads.

The computing system 100 may further incorporate encryption, logging, and monitoring frameworks to support compliance and reliability. Each module may include embedded security checks verifying that incoming data conforms to consent policies before processing. Logging services may capture execution timestamps, module identifiers, and event outcomes for audit purposes. Monitoring agents may track performance metrics such as queue length, recognition latency, and search response time. These utilities may allow administrators to maintain continuous visibility and system health across deployments.

Although FIG. 2 illustrates specific modules and engines, variations may include additional or alternative components that perform equivalent functions. For instance, supplemental analytics modules may evaluate consent trends or usage frequency without altering the described workflow. Similarly, the communication module 202 may operate within cloud-based container environments to improve scalability. Each embodiment may use different programming languages, frameworks, or database technologies depending on infrastructure requirements. The system architecture described with reference to FIG. 2 may therefore support multiple implementations while maintaining the same functional relationships.

The components described with reference to FIG. 2 may be implemented using software, firmware, hardware, or combinations thereof. Execution may occur on physical servers, virtual machines, or containerized platforms interconnected through secure networks. Each module and engine may execute concurrently or sequentially based on workload distribution algorithms. Data interchange among modules may use lightweight message protocols to reduce overhead. The described configuration may enable efficient, consent-compliant processing of likeness recognition, verified content generation, and media search activities across the closed network environment.

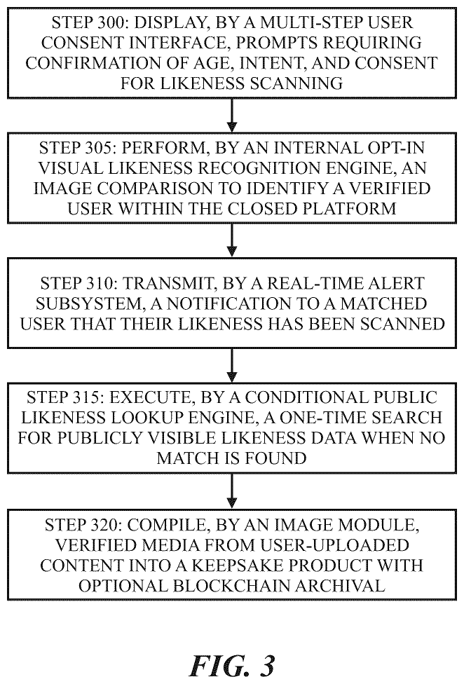

Referring now to FIG. 3, a flowchart 300 illustrates an exemplary method for performing consent-driven visual likeness identification and verified content generation. The steps shown in FIG. 3 may be executed by one or more processors configured to perform the operations of the modules and engines described with reference to FIG. 2. Each step may occur sequentially or concurrently depending on system configuration. The method may be initiated when a user accesses the application program 200 through a computing device connected to the platform network. Each action within the method may be recorded by the database engine 204 for session traceability and compliance verification.

Step 300 may include displaying, by a multi-step user consent interface, a sequence of prompts requiring user confirmation of age, intent, and consent for likeness scanning. The multi-step user consent interface may present interactive elements, such as selectable checkboxes or biometric authorization prompts, that guide the user through three required stages of confirmation. The system may verify the user's age eligibility by comparing the entered date of birth to a predefined threshold and record that the user acknowledges the intent of the scan. A final consent prompt may explicitly ask whether the user authorizes a public likeness lookup, allowing full or partial approval. Once the user confirms all three prompts, the communication module 202 may transmit an encrypted consent token to authorize subsequent system operations.

In one embodiment of Step 300, the system may prevent any further action until the multi-step user consent interface transmits the verified authorization token. The token may contain session identifiers, timestamps, and hash values representing the confirmed consent inputs. The token may be stored temporarily in the database engine 204 and linked to the current user profile managed by the user module 212. This architecture ensures that each likeness scan operation can be directly tied to a corresponding, time-bound consent event. The completion of Step 300 initiates the permission to perform likeness recognition as described in the next step.

Step 305 may include performing, by an internal opt-in visual likeness recognition engine, an image comparison to identify a verified user within the closed platform network. This step may begin when the user uploads an image or initiates a live capture through the image module 210. The image may undergo pre-processing, such as normalization and feature extraction, before being sent to the internal opt-in visual likeness recognition engine 214. The engine may convert the image into a temporary feature map and compare it with previously enrolled likeness data from verified users stored in the database engine 204. The recognition engine may execute these operations within a secure containerized environment to ensure privacy and prevent unauthorized data access.

During Step 305, the internal opt-in visual likeness recognition engine may generate a similarity score that quantifies how closely the captured image matches an enrolled profile. If the similarity score exceeds a configurable threshold, the engine may classify the match as verified and transmit a recognition confirmation message to the user module 212. The engine may immediately delete any temporary vectors or cache data following the completion of the comparison to prevent persistence of biometric information. If no match is detected within the internal network, the system may prepare to execute the optional conditional public likeness lookup engine 220. Step 305 thereby enables privacy-compliant visual identification using data exclusively from verified participants.

Step 310 may include transmitting, by a real-time alert subsystem, a notification to a matched user that their likeness has been scanned. The real-time alert subsystem 218 may receive the recognition confirmation message generated during Step 305 and automatically assemble a structured notification payload. The payload may include identifiers for both the scanning user and the matched user, the timestamp of the recognition event, and a session identifier corresponding to the recorded consent. The alert subsystem may deliver this payload through the communication module 202 using encrypted push notifications or email protocols. Once delivered, the notification event may be logged by the database engine 204 for later review or auditing.

In one embodiment of Step 310, the matched user may be able to acknowledge, approve, or dispute the likeness event through the display module 216. Selecting an acknowledgment option may mark the event as reviewed, whereas a dispute may trigger an internal compliance workflow. This workflow may notify system administrators to evaluate whether the likeness scan occurred in accordance with valid consent parameters. The alert subsystem 218 may generate additional notifications to update both parties regarding resolution status. This closed feedback loop ensures transparency and traceability for all likeness identification activities.

Step 315 may include executing, by a conditional public likeness lookup engine, a one-time search for publicly visible likeness data when no internal match is found. Activation of the conditional public likeness lookup engine 220 may require verification of a valid consent token from Step 300. The lookup engine may access publicly available image databases or web indexes through secure APIs and perform image similarity comparisons using perceptual hashing techniques. The query results may include thumbnails and associated URLs but exclude all biometric identifiers or personal metadata. Once the one-time search is complete, all temporary search data may be deleted, and the lookup session may be terminated.

During Step 315, the conditional public likeness lookup engine 220 may optionally present the user with filters such as location, source type, or date range to refine results. The engine may enforce query limits to prevent excessive searching and to maintain system performance. All lookup activities may be logged and assigned unique session identifiers linked to the originating consent record. Users may review the results via the display module 216 and select any image for further verification or reporting. This step ensures that public likeness searches remain consent-based, temporary, and compliant with privacy regulations.

Step 320 may include compiling, by a Picture Pool and Smartbook module, verified media from user-uploaded content into a keepsake product with optional blockchain archival. Once likeness verification and consent processes are complete, the Picture Pool and Smartbook module 222 may aggregate authorized media assets for creative generation. The module may retrieve user-uploaded files from the database engine 204 and present them through the display module 216 for arrangement. The user may invoke an AI layout assistant to suggest configurations for the keepsake product, which may include digital albums or printed compilations. Upon user confirmation, the blockchain archival subsystem 222 may record immutable ownership metadata, thereby completing the verified content generation process.

In some embodiments of Step 320, the Picture Pool and Smartbook module may also integrate data from the verified multi-input feed search engine 224 to identify additional consent-authorized media. The module may compile these items into the Smartbook design and generate a final output file ready for printing or digital distribution. The blockchain archival subsystem 222 may then generate a unique cryptographic hash representing the product's authorship and creation timestamp. This hash may be stored in the distributed ledger for future verification or authenticity checks. Completion of Step 320 may conclude the workflow for consent-driven visual likeness identification and verified content generation.

In some embodiments, the described system may be deployed as a distributed identity verification network serving multiple third-party applications. Each participating platform may integrate the multi-step user consent interface through an application programming interface (API) that enforces consistent consent capture and token generation across all partners. The internal opt-in visual likeness recognition engine may reside within a federated server architecture, where likeness verification occurs locally at each participating node without transferring biometric data to a centralized repository. The real-time alert subsystem may deliver cross-platform notifications while maintaining audit consistency through shared ledger synchronization. This embodiment may allow multiple entities to adopt the consent framework while preserving data locality and privacy.

In another embodiment, the system may operate within a healthcare or clinical research context. The multi-step user consent interface may serve to obtain participant authorization for capturing and analyzing facial expressions, posture, or movement data for diagnostic or monitoring purposes. The internal opt-in visual likeness recognition engine may track verified participants across visits to ensure continuity of care and secure identification. The blockchain archival subsystem may maintain immutable logs of consent and study participation data, enabling compliance with health information privacy regulations. In this embodiment, the verified multi-input feed search engine may allow clinicians to retrieve participant data by tag, date, or condition while filtering results to only consented content.

In some embodiments, the system may be implemented as a corporate access management and visitor verification system. The multi-step user consent interface may operate as an entry kiosk prompt requesting explicit consent for facial verification before granting building access. The internal opt-in visual likeness recognition engine may compare live camera captures against a database of authorized employees and registered visitors. When a match occurs, the real-time alert subsystem may notify security personnel or designated hosts of the arrival event. The conditional public likeness lookup engine may assist in verifying unknown individuals by scanning open-source datasets for previously authorized public profiles, thereby enhancing physical security without breaching privacy.

Another embodiment may involve a social content verification and authenticity platform where users confirm the origin of digital images or videos. The Picture Pool and Smartbook module may allow creators to assemble collections of verified content, while the blockchain archival subsystem may certify ownership and creation timestamps. The verified multi-input feed search engine may permit searches for original or derivative media based on image similarity or ownership hash. The real-time alert subsystem may notify creators when their verified media appears in external networks or marketplaces. Such a configuration may help reduce impersonation and media falsification while maintaining a consent-based record of ownership.

In certain embodiments, the system may support lawful investigative or compliance review workflows in collaboration with regulated organizations. The conditional public likeness lookup engine may execute likeness searches restricted to authorized law enforcement or compliance accounts operating under active warrants or legal authorizations. Each search may still require a valid consent token generated by an administrative or judicial requestor, preserving system integrity and accountability. The blockchain archival subsystem may store immutable audit trails verifying the purpose and scope of each query. This configuration may ensure that the technology can be lawfully employed under controlled, traceable, and transparent oversight.

The system may also be configured for event-based networking and attendee verification at conferences, trade shows, or private gatherings. The multi-step user consent interface may request attendees'consent to share likeness data for digital introductions or access privileges. The visual likeness recognition module may streamline entry check-in processes by identifying registered participants as they arrive. The Picture Pool and Smartbook module may then generate group albums or Smartbooks using event media uploaded by verified attendees. Optional activation of the blockchain archival subsystem may create verifiable proof of attendance or authorship associated with the event record.

In another embodiment, the system may function as a secure e-commerce identity and transaction validation service. The multi-step user consent interface may authorize identity verification before processing high-value or restricted transactions. The visual likeness recognition module may verify that the user initiating payment matches the identity linked to a verified account. The real-time alert subsystem may generate notifications for both buyer and seller confirming identity verification and transaction status. The blockchain archival subsystem may permanently record the transaction metadata, including buyer identity, seller identity, and timestamps, for dispute prevention and authenticity assurance.

The described platform may also support educational or certification environments where exam proctoring, or remote learning verification requires secure identity checks. The internal opt-in visual likeness recognition engine may authenticate each participant at login and at periodic intervals during testing sessions. The multi-step user consent interface may obtain approval for recurring verification checks prior to exam initiation. The real-time alert subsystem may generate notifications if unrecognized users attempt to access a session. The blockchain archival subsystem may store immutable attendance and verification data for institutional recordkeeping.

In certain embodiments, the system may be utilized for artist and influencer content licensing management. The Picture Pool and Smartbook module may aggregate verified media from licensed creators, and the blockchain archival subsystem may record license terms, royalties, and attribution metadata. When third-party entities request use of specific likenesses or media, the verified multi-input feed search engine may identify relevant assets and confirm whether consent and license remain active. The real-time alert subsystem may then notify creators of new usage requests or completed transactions. This configuration may simplify digital rights management while ensuring that each likeness-based transaction remains auditable and voluntary.

Another alternative embodiment may deploy the system as a decentralized identity validation service integrated into metaverse or extended reality environments. The multi-step user consent interface may appear as a virtual onboarding portal requesting authorization for likeness representation within immersive spaces. The internal opt-in visual likeness recognition engine may link physical user attributes to corresponding avatars for authenticity verification. The Picture Pool and Smartbook module may store user-generated virtual media, and the blockchain archival subsystem may record verifiable ownership of digital assets or avatars. This embodiment may enable consent-based identity continuity across virtual ecosystems while maintaining strict control over user likeness and privacy.

The described system provides a specific improvement to computer technology by introducing a structured and verifiable consent-based data processing architecture that governs visual likeness recognition, content generation, and secure data retrieval. Each component, including the multi-step user consent interface, the internal opt-in visual likeness recognition engine, and the real-time alert subsystem, performs concrete technical operations implemented through specialized hardware and software integration. The system requires tangible computing components such as processors, servers, and non-transitory memory configured to execute encrypted data exchanges between networked modules. Unlike abstract data management or mental processes, the disclosed operations modify the way computer systems capture, authorize, and handle biometric data in real time. The claimed features therefore provide a practical application that transforms general-purpose computing infrastructure into a privacy-compliant, consent-governed verification system.

The claimed system and method address a specific technological problem associated with unauthorized biometric processing and untraceable data transactions. Prior computer-based systems have been unable to provide real-time verification that every likeness scan or content generation event was preceded by explicit user consent. The described multi-step user consent interface and tokenized authorization process introduce a new data-handling mechanism that enforces consent at the system level, ensuring that subsequent computing processes operate only under verified authorization conditions. This architecture changes the operational behavior of the computing platform by embedding consent validation into each executable instruction that involves user data. As such, the claims recite an inventive concept that is significantly more than an abstract rule or administrative procedure.

The system's improvements extend beyond mere automation of human decision-making by reconfiguring the underlying data flow and interaction between modules. For instance, the internal opt-in visual likeness recognition engine is implemented as a secured processing environment that performs temporary feature extraction and ephemeral comparison, thereby preventing the creation of persistent biometric data stores. The technical configuration of ephemeral vector processing, encrypted feature caching, and post-completion data deletion provides a measurable improvement to data security and computing efficiency. These enhancements directly improve the functioning of the computer system itself, as data processing operations now execute under cryptographic isolation rather than as generic pattern matching routines. The practical result is a computing system that is faster, safer, and demonstrably more compliant with data protection requirements.

The disclosed invention also integrates multiple distinct computing technologies in a non-conventional manner. The combination of the real-time alert subsystem, conditional public likeness lookup engine, and blockchain archival subsystem creates a distributed, verifiable event tracking system that ensures full auditability of biometric and content transactions. The blockchain archival subsystem is not used as a generic ledger, but as an integral component of a multi-stage verification framework that records consent, recognition, and ownership metadata across interconnected nodes. This coordinated operation across heterogeneous computing components constitutes a technical improvement in distributed computing and data integrity assurance. The resulting system transforms traditional static data records into verifiable, time-stamped digital proofs that cannot be duplicated or falsified.

The claimed subject matter further avoids preemption concerns because it is narrowly directed to a specific technological implementation that requires defined modules, engines, and subsystems operating in concert. Each step of the method, including consent capture, recognition processing, alert transmission, lookup execution, and verified content compilation, depends on inter-module communication through authenticated network connections. These structural and operational interdependencies ensure that the claims do not monopolize the general concept of consent or recognition, but rather recite a specific improvement in the technological environment of computer-based identity verification and media generation. The architecture can only be performed by programmed computing devices executing specific algorithms for encryption, token generation, and distributed ledger registration. The scope of the claimed system is therefore limited to a technological solution implemented through hardware and software cooperation.

From a practical standpoint, the described modules improve the reliability, transparency, and efficiency of computer-based recognition systems. The multi-step user consent interface introduces a new form of dynamic access control that restricts computational resources until user consent has been cryptographically verified. This eliminates previously known race conditions in which background processes operated before authorization completion. The real-time alert subsystem provides immediate feedback loops between processing nodes, reducing latency in user notifications and ensuring continuous synchronization across the computing network. These tangible enhancements constitute technological improvements to computer functionality, demonstrating that the claimed subject matter is not directed to an abstract idea.

The described processes also provide a concrete transformation of digital information into authenticated, immutable data objects. For example, the Picture Pool and Smartbook module, in combination with the blockchain archival subsystem, transforms user-generated files into cryptographically verifiable digital assets that can be independently validated. The transformation involves specific algorithmic steps, including hashing, key generation, and timestamp verification, that produce a distinct technical effect within the computer system. These operations cannot be performed as a mere mental process or abstract manipulation of information, as they require programmed execution on non-transitory computer-readable media.

Furthermore, the system incorporates novel machine-to-machine communication pathways that enhance overall computing efficiency. The verified multi-input feed search engine communicates directly with the database engine and visual likeness recognition module to process multi-parameter queries without human intervention. This configuration reduces processing overhead and network latency by dynamically routing search requests through localized data caches rather than centralized servers. Such improvements in processing efficiency and latency are recognized by the USPTO as evidence of eligibility under MPEP § 2106.05(a) because they improve the functioning of the computer itself. The architecture therefore represents a technological innovation rather than an abstract method of organizing human activity.

Collectively, these technical features demonstrate that the claimed subject matter provides a specific, concrete, and practical improvement in computer functionality, network security, and data management. Each embodiment utilizes computing resources in a novel configuration to achieve consent-based biometric processing and verified content generation not achievable by generic systems. The described improvements are rooted in computer technology and address problems arising specifically from the implementation of digital recognition and privacy compliance systems. The operations of the described modules cannot be performed as mental processes or with pen-and-paper equivalents, as they rely on specialized algorithms, cryptographic protocols, and distributed data coordination.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for consent-driven visual likeness identification and verified content generation, the system comprising:
at least one user computing device in operable connection with a user network;
a multi-step user consent interface configured to require affirmative confirmation of age, intent, and authorization prior to initiating a scan;
n image module configured to generate verified digital or physical keepsakes from user-uploaded media, wherein all media originates from verified users within the closed platform.

2. The system of claim 1, wherein the multi-step user consent interface requires the user to affirm being at least sixteen years of age before a likeness scan is permitted.

3. The system of claim 1, wherein the internal opt-in visual likeness recognition engine is restricted to operate solely within a verified user database without external data scraping or third-party integration.

4. The system of claim 1, wherein the real-time alert subsystem generates an in-application notification stating that a likeness scan has occurred and identifies the scanning user by name.

5. The system of claim 1, wherein the conditional public likeness lookup engine performs a one-time, session-based search without storing or caching any biometric vectors, identifiers, or confidence scores.

6. The system of claim 1, wherein the Picture Pool and Smartbook module includes a tag-activated Picture Pool that allows verified users to upload, view, and organize event-based media collections.

7. The system of claim 6, wherein the Picture Pool and Smartbook module further comprises an AI layout assistant configured to provide arrangement and captioning suggestions only after user initiation of a Smartbook creation command.

8. The system of claim 1, further comprising a Remove-Me control mechanism configured to allow a tagged user to withdraw consent and exclude their likeness from shared media or keepsakes.

9. The system of claim 1, wherein the Picture Pool and Smartbook module optionally employs a blockchain archival subsystem configured to generate immutable ledger entries including timestamp, ownership, and authorship metadata.

10. The system of claim 1, further comprising a verified multi-input feed search engine configured to receive one or more inputs including keyword, date, location, identity tag, or uploaded likeness image to perform searches within a closed, consent-based network.

11. The system of claim 10, wherein the verified multi-input feed search engine processes user queries across three structured layers including: a personal uploaded media, a plurality of shared or tagged media, and a likeness-matched verified user media.

12. A computer-implemented method for performing consent-drive visual likeness identification and verified content generation, the system comprising:
displaying, by a multi-step user consent interface, a sequence of prompts requiring user confirmation of age, non-malicious intent, and consent for public likeness lookup;

13. The method of claim 12, wherein the conditional public likeness lookup engine automatically terminates all search operations upon completion of the single authorized search session.

14. The method of claim 12, further comprising transmitting, by the real-time alert subsystem, an auditable record of the likeness scan event to both the initiating and matched users.

15. The method of claim 12, wherein the Picture Pool and Smartbook module restricts AI-based automation to layout assistance after explicit user selection of images for inclusion.

16. The method of claim 12, further comprising recording, by the blockchain archival subsystem, immutable verification data representing ownership of the finalized Smartbook or keepsake.

17. A system for identifying individuals and generating transaction reports and personalized photo books within a social commerce platform, the system comprising:
at least one user computing device in operable connection with a user network;
operate a multi-step user consent interface requiring explicit user authorization before any visual likeness scan is initiated;
publicly visible thumbnails and URLs; and

18. The computer-readable medium of claim 17, wherein execution of the multi-step user consent interface prevents further system operation unless all required consent statements are affirmatively confirmed.

19. The computer-readable medium of claim 17, wherein the conditional public likeness lookup engine excludes all results lacking prior consent from verified platform users or public domain indexing.

20. The computer-readable medium of claim 17, wherein the Picture Pool and Smartbook module is further configured to export the verified keepsake as both a digital collectible and a physical printed product.
